(19) United States
(12) Patent Application Publication
(10) Pub. No.: US 2014/0305673 A1
(43) Pub. Date: Oct. 16, 2014

(54) FOLDING ACCESSORY CABLE FOR PORTABLE ELECTRONIC DEVICES

(71) Applicant: Charles J. Kulas, San Francisco, CA (US)

(72) Inventor: Charles J. Kulas, San Francisco, CA (US)

(21) Appl. No.: 13/862,241

(22) Filed: Apr. 12, 2013

(51) Int. Cl. H01B 7/06

(52) U.S. Cl. CPC H01B 7/06
USPC 174/69; 174/70 R

(57) ABSTRACT

Embodiments of the invention provide a folding cable. One embodiment includes stiff sections of the cable linked by flexible joints. The joints exert a small folding force on the cable so that when not pulled extended the cable tends to fold together in an accordion style to a length that approximates the portable device, such as a mobile phone, with which the cable is used. Various other embodiments are disclosed.

### BACKGROUND

Embodiments of the invention relate generally to electrical signal cables and more specifically to a headphone cable that can be folded in an accordion style.

Many electronic devices are often used with an accessory that is connected to the device with a wire cable. Portable handheld computing devices such as cell phones, personal digital assistants (PDAs), audio players, cameras, global positioning satellite (GPS) devices, smart glasses, smart watches, portable games, or other devices, are often used with various hardwired accessories. For example, headphones, speakers, microphones, user input controls, etc., are types of accessories that may be connected to the devices with a hardwired cable. A problem with these cables is that the cables and cable endpoints such as connectors, earphones, etc., can become tangled or otherwise unorganized. This is especially true when the cable is stored with a portable electronic device in a small compartment such as a purse, pocket, case, etc.

### SUMMARY

Embodiments of the invention provide a folding cable. One embodiment includes stiff sections of the cable linked by flexible joints. The joints exert a small folding force on the cable so that when not pulled extended the cable tends to fold together in an accordion style to a length that approximates the portable device, such as a mobile phone, with which the cable is used.

One embodiment provides an apparatus for folding a cable of an accessory for a mobile phone, the apparatus comprising: a first stiff section along a first portion of a wire in the cable; a second stiff section along a second portion of the wire in the cable; a joint flexibly coupled between the first and second stiff sections; and a force mechanism for applying a force so that the first and second stiff sections are moved toward each other.

### BRIEF DESCRIPTION OF THE DRAWINGS

FIG. 1 illustrates a particular embodiment of a folding accessory cable;

FIG. 2 shows a prior art headphone cable;

FIG. 3 illustrates details of an embodiment of a joint;

FIG. 4 shows a cross section of a stiff section;

FIG. 5 illustrates a hinge forming a joint between stiff sections;

FIG. 6 illustrates a wire clamping mechanism in a first position;

FIG. 7 illustrates a wire clamping mechanism in a second position;

FIG. 8 shows an embodiment where there is a twist in the wire;

FIG. 9 shows an embodiment where the wire is subjected to multiple twists;

FIG. 10 shows a portion of a continuous stiff section including a bend;

FIG. 11 shows folding by magnetic force.

### DETAILED DESCRIPTION OF EMBODIMENTS

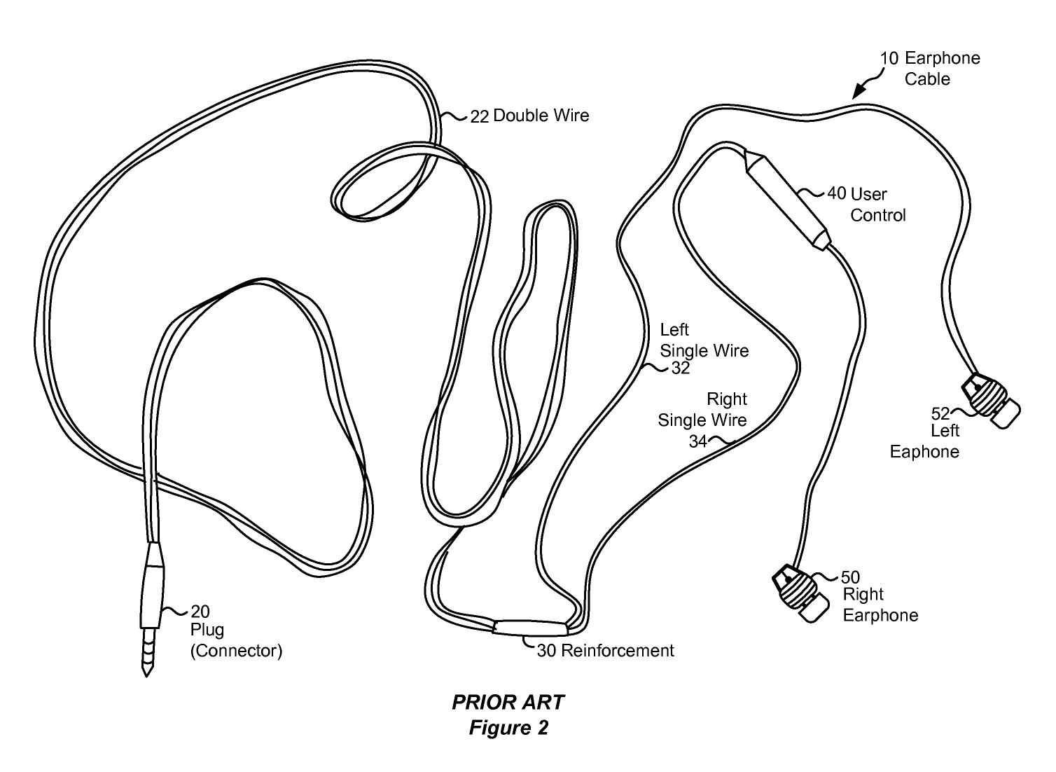

FIG. 2 shows a prior art headphone cable 10. Headphone cable 10 includes various parts such as plug 20, a section of double wire 22, reinforcement 30, left single wire 32, right single wire 34, user control 40, right earphone 50 and left earphone 52. FIG. 2 shows but one example of a typical accessory cable. It should be apparent that many variations are possible.

In FIG. 2, plug 20 is used to connect the cable to a device such as a portable electronic device. Any type of plug, socket or other connector may be used such as a Universal Synchronous Bus (USB) connector, 2.5 mm, 3.5 mm, ¼ inch, etc. plugs; D-connector, coaxial, multi-pin connector, DIN connector, etc. The connector need not be mechanical but can be held in place at the device magnetically or by other means. In general, the connector can be any shape or type.

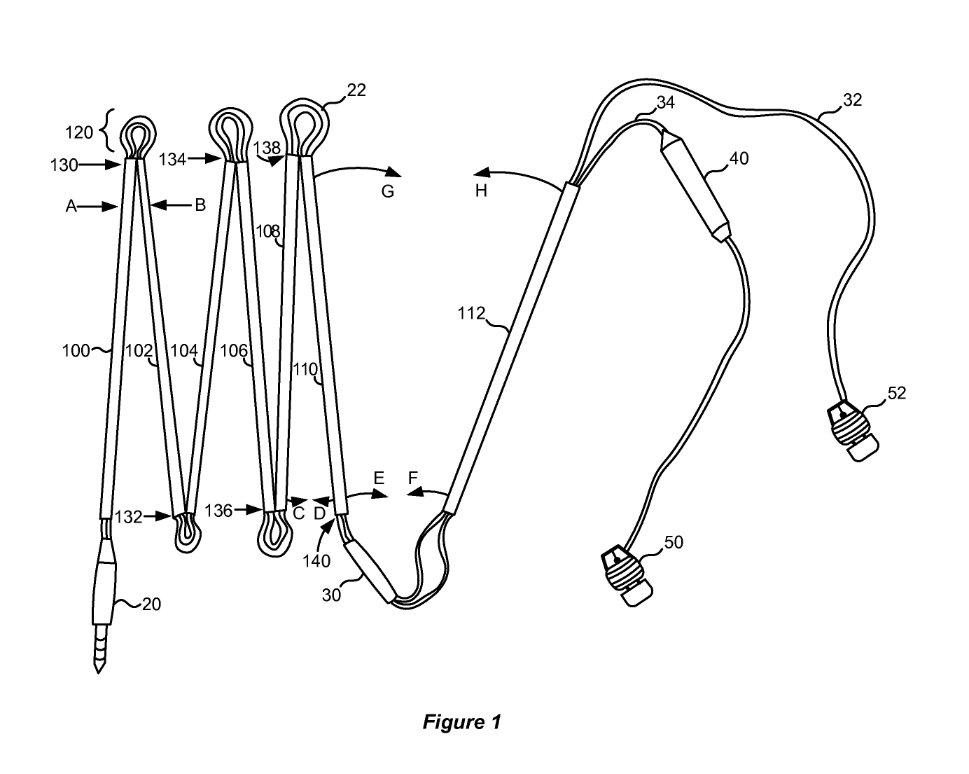

A 2-conductor wire pair in the form of double wire 22 conveys electrical signals to and from plug 20. In the design of FIG. 1, the double-wire continues up to reinforcement 30 where it is split off into two single wires 32 and 34. Reinforcement 30 serves to prevent the double wire portion of the cable to be split into two wires as, for example, if a user were to cause a force to pull the two wires of the double wire apart. In other designs, no reinforcement part may be used as sometimes it can be desirable to allow a user to increase the length of the single wires by pulling the double wire portion apart.

To the right of reinforcement 30 is a section of single wire including left single wire 32 and right single wire 34. Although the wires may be referred to as “left” and “right” the user can use either wire for a left and or right side connection. Left single wire 32 is electrically coupled to left earphone 52 which fits into an ear of the user. Right single wire 34 connects to user control 40 and then continues to right earphone 50. User control 40 can include simple controls such as an on/off or “answer call” button, volume control, microphone or other sensor, etc. Either the left or right earphone may be used in the user's left or right ear. In other types of accessory cables, different parts may be used. Some parts may be omitted. For example, user controls may not be provided. There may be single wires along the entire length of a cable. More than two conductors may be used. An interconnection between the earphones may be provided.

Many different designs and types of accessory cables can be used. Any number of conductors may be included within a “wire.” Although narrow gauge wires (e.g., 22 gauge or higher) are often used in accessory cables, any suitable gauge or conductor and/or insulator sizes can be used. Any suitable flexible material might be used for the insulation of a wire. Other types of cables need not terminate in separate earphones. For example, headphones provide a single assembly to which one or more wires can be connected. A plug can be provided on both ends so that the cable can connect an electronic device to another electronic device such as a cell phone connected to external speakers. Other arrangements are possible.

FIG. 1 illustrates a particular embodiment of a folding accessory cable. In FIG. 1, the cable of FIG. 2 has been fitted with stiff sections 100, 102, 104, 106, 108, 110 and 112. Items marked with the same reference numbers between FIGS. 1 and 2 indicate the corresponding components. Thus, FIG. 1 shows a folding cable assembly that includes the parts of FIG. 2 of plug 20, a section of double wire 22, reinforcement 30, left single wire 32, right single wire 34, user control 40, right earphone 50 and left earphone 52.

In FIG. 1, the cable of FIG. 2 has been fitted with stiff sections 100, 102, 104, 106, 108, 110 and 112. This provides a folded cable that when folded has a length (including wire loop sections and joints) that is comparable with the length of a cell phone or other small portable device (e.g., 8 cm to 15 cm long) so that the folded cable can be stored easily next to the cell phone of similar length. It should be apparent that other lengths of stiff sections are possible and any suitable length may be used.

In a particular embodiment pairs of ends of stiff sections abut each other and are movably joined at their endpoints to make successive joints to form an accordion-style configuration. In FIG. 1, stiff section 100's end at 130 is joined with stiff section 102's end which is also at 130. By making the join elastic, a force is placed on the stiff sections so that the joint at 130 moves stiff section 100 in the direction A and moves stiff section 102 in the direction B. This “folding force” quality of the joint at 130 causes stiff sections 100 and 102 to fold toward each other. Similarly, joint 132 causes stiff sections 102 and 104 to fold toward each other. Joint 134 causes stiff sections 104 and 106 to fold together. Joint 136 causes stiff sections 106 and 108 to fold together. Joint 138 causes stiff sections 108 and 110 to fold together. Note that complete folding is not necessary to obtain advantages. In general, any amount of folding force may provide benefits by causing the cable to compact itself and prevent tangling. In other embodiments, no folding force may be necessary and advantages may still be realized. For example, the presence of the stiff sections by themselves, without a folding force, will serve to keep the cable untangled. In such a case, the joints need not be present and one or more stiff sections can remain unattached from the others.

Not all of the stiff sections need to be handled in the same manner. For example, reinforcement 30 may make it impractical to use a joint at 140. In this case stiff section 112 can be unattached to the other stiff sections. In general, any manner of mixing different lengths, numbers and types of stiff sections with joints or other mechanisms for applying a force (“force mechanisms” as discussed below) can be employed, as desired. Different sizes of stiff sections can be used for a given cable. Different lengths of wire bends at the joints can be used, as shown at wire bend 120 in FIG. 2. Not all, or even most, of the cable need be provided with stiff sections. Any one or more wires or wire groups can be applied with one or more stiff sections. For example, stiff sections 100 through 110 are applied to double wire sections while stiff section 112 is applied to two separate single wire sections. Again, the number and characteristics of these stiff sections is optional and can change with different embodiments.

A wire is typically characterized by a conductor and surrounding insulation. Depending on the characteristics of the conductor—e.g., gauge, solid or stranded, metal type, etc.—and the type of insulation, the wire section can have different bending and elastic characteristics. As such, the choice of characteristics for the stiff sections will vary with design choice according to wire characteristics and other characteristics of the overall cable such as endpoints (connector, earphones, etc.), inter-cable variations (e.g., reinforcements, wire groupings (single, double, etc.) and the purpose or use of the cable. For example, if the cable is designed to be used with a mobile phone then it is often advantageous to have the cable fold to be about the same length as the mobile phone. Also, the force required to stretch out or lengthen the cable should be relatively low since otherwise the folding forces might readily pull the earphones out of the user's ears. In an application where the cable has mechanical connectors at each end then the folding forces can be larger since a plug, socket or other mechanical connector usually requires larger forces to disconnect than pulling an earphone out of an ear.

In the particular embodiment shown in FIG. 1, six stiff sections of approximately 9 to 10 cm in length and 2.5 to 3.5 mm in diameter are made of thin tube plastic such as polypropylene of approximately 0.15 to 0.25 mm thickness. In other embodiments, other sizes and types of materials (e.g., polystyrene, etc.) may be used and the shape need not be tubular. Each section is jointed to one other section including sufficient folding force to create a self-folding portion of the cable with 5 joints. An additional stiff section of approximately the same length as the others is used to cover a portion of the single wire run. In another embodiment, a joint could be provided to join stiff sections 110 and 112 and provide a folding force in the E and F directions. Additional attraction or folding forces can be applied in the direction G and H as discussed below. The stiff sections and joints or other mechanisms can be part of the design of the cable and created at a time of manufacture of the cable. Or the folding apparatus (i.e., stiff sections and joints or other mechanisms to apply a folding force) can be provided as an after-market add-on.

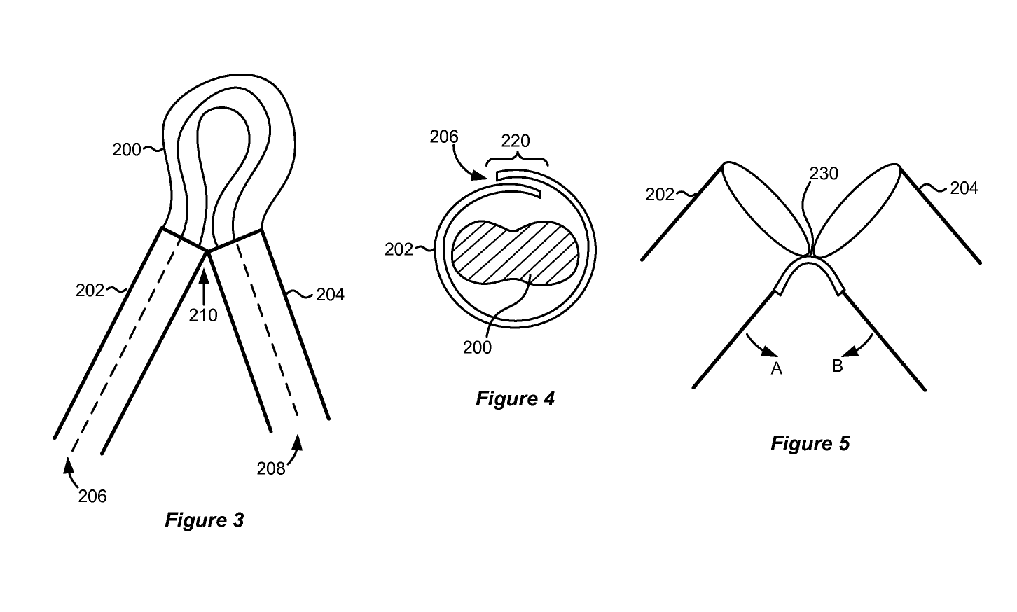

FIG. 3 illustrates details of an embodiment of a joint. In FIG. 3, wire bend 200 is shown near joint 210 between stiff sections 202 and 204. Dashed lines 206 and 208 represent cuts, or openings in the structure of stiff sections 202 and 204, respectively.

FIG. 4 shows a cross section of stiff section 202 of FIG. 3. In FIG. 4, stiff section 202 has a cut 206 along its length so that stiff section 202 can be separated for insertion of wire 200. When allowed to close, stiff section 202 is elastic and has a “memory” of its shape so that it tends to close on itself with an overlap 220 to help seal and hold wire 200. Naturally, design tradeoffs can be made as to the thickness, diameter, material, elasticity, shape, length, etc. of stiff section 202, and any desirable design may be achieved. In other embodiments, the stiff section need not be self-closing, but may be closed or have the wire retained by other means such as with glue, zip-tie, elastic bands, velcro, snaps, zippers, or any suitable closing or retaining mechanism.

FIG. 5 illustrates a hinge 230 forming a joint between stiff sections 202 and 204. In one embodiment, hinge 320 is a force mechanism that causes a folding force to move stiff sections 202 and 204 toward each other in the direction A and B, respectively. In other embodiments, hinge 320 need not cause a folding force or may provide a negligible folding force or even an unfolding force (in the directions opposite to A and B). Such an unfolding force may be desirable, for instance, if it is desired for a cable to tend to be in an elongated configuration but still foldable as when a user folds the cable by hand. In various embodiments, the degree of force, and the mechanism for applying the folding, unfolding, or no or negligible, force is a design choice that can vary depending upon the particular application or use.

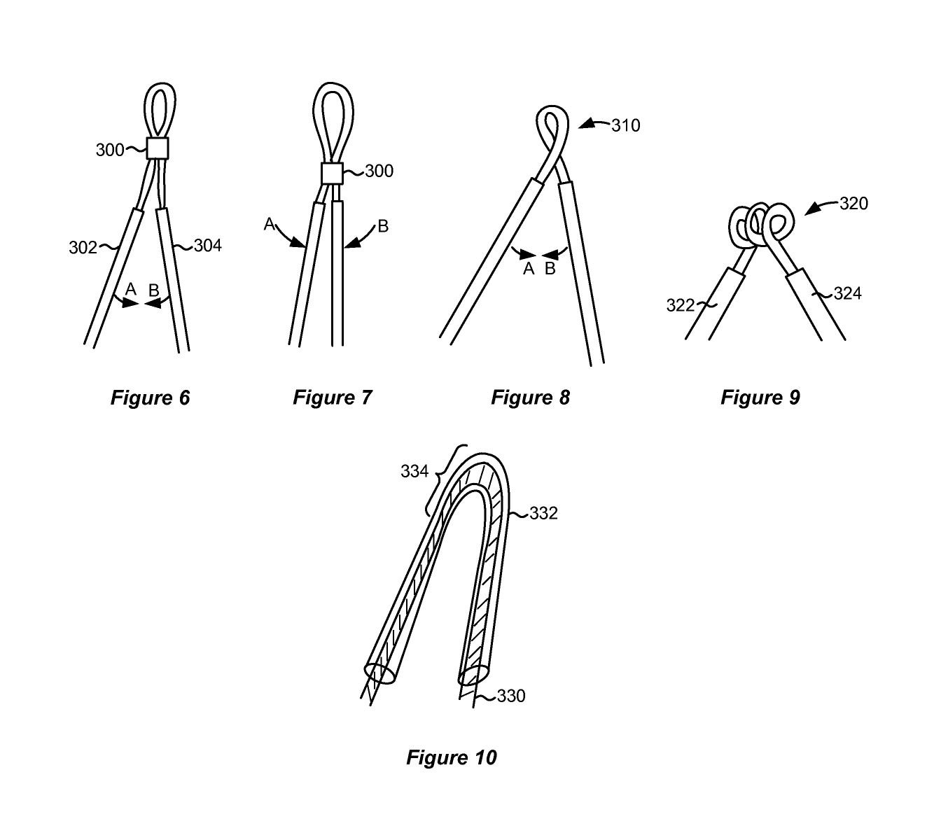

FIG. 6 illustrates an embodiment whereby a clamping mechanism is used on the wire to cause a folding force in the direction A and B. In FIG. 6, clamp 300 causes the wires to be pushed together. Because the wires, themselves, have a stiffness, elasticity, and shape memory, they tend to push against the stiff sections 302 and 304 in the directions A and B, respectively. In this respect, the wire being held in place by the clamp acts as the force mechanism. The clamp can be made of any sufficient material and design. For example, in various embodiments any of the closing mechanisms mentioned, above, and any other suitable mechanisms now known or discovered in the future, may be used.

FIG. 7 illustrates that as the clamping mechanism is moved closer to the stiff sections the folding force will tend to increase in the directions A and B.

FIG. 8 shows an embodiment where there is a twist in the wire at 310 which can be used to apply a folding (or other) force or to otherwise cause the cable to be organized more easily. As with all illustrations in this document, variations can be made such as to include a joint or additional ways to cause a folding force in the directions of A and B (or in other directions as described herein). The wire and cable design, and the design of the various components to apply a force to the cable can vary as described herein.

FIG. 9 is yet another embodiment where the wire is subjected to multiple twists or curls at 320 that may further increase or affect the desired force or otherwise influence the way the wire behaves with respect to the stiff sections 322 and 324.

FIG. 10 shows a portion of a continuous stiff section that can be integral with the wire or cable, or can be provided as a tray or tube or other separate part for mating with the cable. In FIG. 10, wire 330 is housed within stiff section 332. Stiff section 332 in this case has a pre-formed bend at 334 so that a small force (e.g., a user gently stretching the cable, effect of gravity on the cable hanging down from a user's ears, tension stretching the cable as it is connected between the user's ears and the device, etc.) will unbend the bend, yet when no force is applied (e.g., the user stops stretching the cable), or when a reverse force is applied (e.g., the user tries to fold up the cable), then the bend reverts back to its “unstressed” state of a predetermined bend as shown in FIG. 10.

Some embodiments using stiff sections and/or joints may be made as part of the cable itself at a time of manufacture. For example, stiff sections may merely be section that have more or different insulation than the other relatively non-stiff sections. Joints can be created as part of a molding of insulation or other materials. Additional parts can be affixed permanently or semi-permanently to the cable to achieve the embodiments described herein or to achieve the detailed effects.

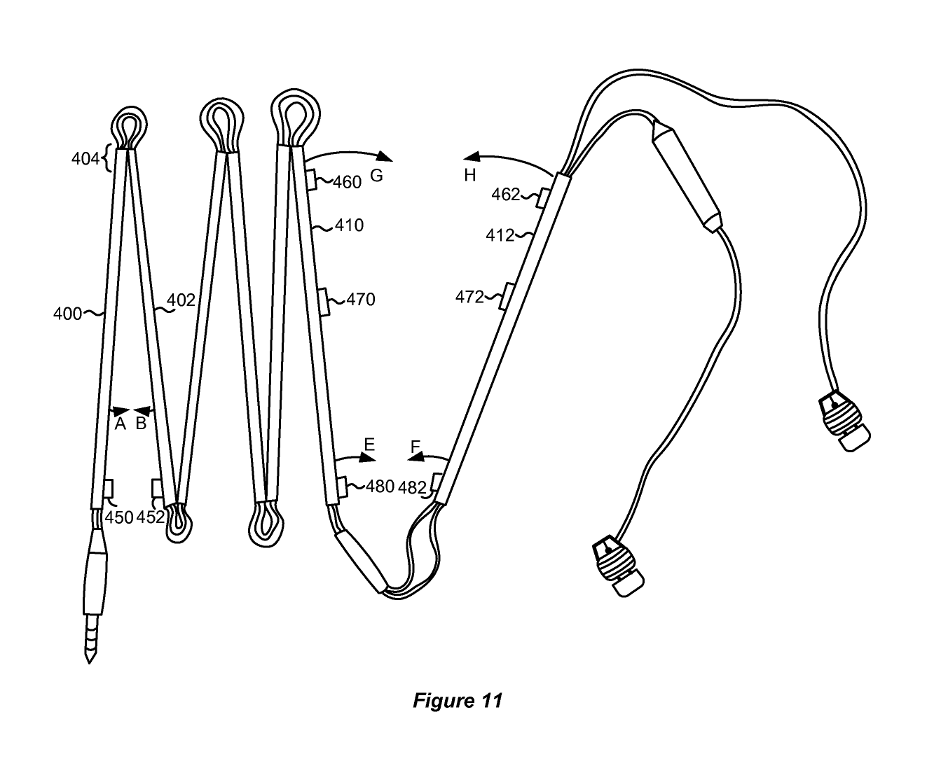

FIG. 11 shows various embodiments whereby a force such as a folding force is applied magnetically. Magnets such as 450 and 452 can be used to cause an attractive or repulsive force between stiff sections such as 400 and 402. In an embodiment where the stiff sections 400 and 402 are joined at 404, magnets 450 and 452 can attract to cause folding forces in the directions A and B, respectively. In other cases where stiff sections are not joined, such as stiff sections 410 and 412, magnetic effects can be used at, for example, 460 and 462; 470 and 472; 480 and 482, etc. In some embodiments, pairs of magnets may not be necessary as one magnet may provide sufficient force by attracting the metal in the conductor of one or more portions of the wire. In general, any number, type and positioning of magnets may be used to create the desired forces.

In some embodiments that use magnetic attraction, stiff sections may not be needed. Or the stiff sections may have different arrangements than those shown herein. In one approach, discrete or visible magnetic elements need not be used as the insulation or stiff sections themselves may be made magnetic. For example, the wire insulation, stiff sections, or joints can be made from magnetic organic polymer, or magnetic rubber, etc. so that these parts may be inherently magnetic. An electromagnetic embodiment allows small electromagnets in locations such as those discussed in connection with FIG. 11, to be activated by a user control so that the cable can be activated to, for example, self-fold upon user activation. In this case an electrical circuit that can utilize the cable's own wires (or additional wires) to carry the current for the electromagnetic actuation can be used, along with a battery or other power supply. The power supply can be part of the cable or can be obtained from a host device, inductively through the air, by solar electricity, or from other sources. In some embodiments, the electromagnetic effect need only be activated momentarily so that the cable can be easily gathered and stored and then the electromagnetic effect can be stopped.

Although particular embodiments have been described, many variations are possible. For example, although the embodiments have been described primarily with respect to hardwired cables, other types of electrical or communication cables can be used. Fiber optic cables may be susceptible for use with functionality discussed herein.

Larger devices that may be adaptable for use with features described herein even though the devices may be considered too large for easy “handheld” or “portable” operation. For example, tablet or slate computers such as the iPad™ by Apple Computer, Inc. can be used even though these devices are significantly larger than cell phones.

Any suitable programming language can be used to implement the routines of particular embodiments including C, C++, Java, assembly language, etc. Different programming techniques can be employed such as procedural or object oriented, scripts, interpreted or compiled code, etc. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nano-engineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

1. An apparatus for folding a cable of an accessory for a mobile phone, the apparatus comprising:
a first stiff section along a first portion of the cable; a second stiff section along a second portion of the cable; a first joint flexibly coupled between the first and second stiff sections;
a third stiff section along a third portion of the cable;
a second joint flexibly coupled between the second and third stiff sections;
a first force mechanism for applying a first force so that the first and second stiff sections are moved toward each other; and
a second force mechanism for applying a second force so that the second and third stiff sections are moved toward each other.

2. The apparatus of claim 1, wherein the accessory is a headphone.

3. The apparatus of claim 1, wherein there are three or more stiff sections and wherein at least one stiff section is not coupled to another stiff section.

4. The apparatus of claim 1, wherein the stiff sections comprise tubes.

5. The apparatus of claim 4, wherein a stiff section includes a slit down its length for receiving a portion of wire of the cable.

6. The apparatus of claim 1, wherein the force mechanism includes a pre-formed plastic joint.

7. The apparatus of claim 1, wherein the force mechanism includes a portion of the wire.

8. The apparatus of claim 7, further comprising:
a clamping mechanism for clamping a first portion of the wire to a second portion of the wire.

9. The apparatus of claim 1, wherein the force mechanism includes a pre-formed bend.

10. The apparatus of claim 1, wherein the force mechanism includes a twist of the wire.

11. The apparatus of claim 1, wherein the force mechanism includes molding insulation to form a joint.

12. The apparatus of claim 1, wherein the force mechanism includes a hinge.

13. The apparatus of claim 1, wherein the force mechanism includes a magnet.

14. The apparatus of claim 13, wherein the magnet includes an electromagnet.

15. The apparatus of claim 1, wherein one or more of the stiff sections, joints or force mechanisms are made at a time of manufacture.

16. The apparatus of claim 1, wherein one or more of the stiff sections, joints or force mechanisms are made after a time of manufacture.

17. The apparatus of claim 1, wherein at least one of the force mechanisms acts to provide an unfolding force.

18. The apparatus of claim 1, further comprising:
at least one pair of adjacent stiff sections including a particular joint between the pair that does not include a force mechanism acting on the particular joint.
